(19) United States
(12) Patent Application Publication
(10) Pub. No.: US 2002/0093590 A1
(43) Pub. Date: Jul. 18, 2002

(54) Synchronising a plurality of independent video signal generators

(76) Inventors: Douglas H. Hodgkiss, Surrey (GB); Geoffrey L. Thiel, Surrey (GB)

Correspondence Address: FISH & RICHARDSON, PC, 4350 LA JOLLA VILLAGE DRIVE, SUITE 500, SAN DIEGO, CA, 92122, US

(21) Appl. No.: 10/043,906

(22) Filed: Jan. 11, 2002

(30) Foreign Application Priority Data
Jan. 12, 2001 (GB) 0100977.8

(51) Int. Cl. H04N 9/475

(52) U.S. Cl. 348/500

(57) ABSTRACT

Apparatus for synchronising a plurality of independent video signal generators comprises a first input (12) for receiving field or frame synchronising signals from a first video signal generator, a second input (14) for receiving field or frame synchronising signals from a second video signal generator, a comparator (13) for comparing the phase of the first and second synchronisation signals, a master clock generator (1), a slave clock generator (4), the slave clock generator (4) having a frequency different from that of the master clock generator (1), means for applying the master clock signal to a first output (7) for application to the first video signal generator, means for applying the slave clock signal to a second output (9) for application to the second video signal generator, and means (5) for means for applying the master clock signal to the second output (9) in place of the slave clock signal when the synchronising signals from the first and second synchronising signals are in phase. A second comparator (3) is provided for comparing the phase of the master clock (1) and the slave clock (4) so that the operation of the means (5) for applying the master clock (1) to the second output (9) is dependent also on the master (1) and slave (4) clocks being in phase.

The invention relates to a method of and apparatus for synchronising a plurality of independent video signal generators.

In any virtual environment, the image viewed by the user consists of Computer Generated Imagery (CGI) displayed on a viewing device such as a monitor, projection screen etc. For many applications, a multiple view is required which is achieved by having several channels of CGI where the output videos are displayed butted up to each other or even overlapped and edge blended together to present a seamless view.

To maintain a cohesive display the different video channels need to be synchronised vertically such that any object that moves with respect to the viewer is in exactly the same place at the same time on adjacent channels. Failure to implement such synchronisation results in the apparent tearing of an object.

Many applications also demand an anti-aliased image. One of the ways of achieving this is to generate a number of sub-images which have each been generated with a small offset between them. The output image is then generated by averaging all of the source images. This can only work effectively if the respective input pixels from each sub-image are accurately aligned in time.

Many such CGI systems consist of proprietary hardware designs and control of individual channels is integral to the design. For the vertical synchronisation it is possible in such designs to lock to the video timing of an incoming signal and generate the synchronisation signals for the slave hardware from it.

In the case of pixel synchronisation the individual channels are typically generated from the same source pixel clock and all horizontal and vertical timing is generated from the same source.

The hardware solutions for high end 3D graphics are being driven by the games and special effects markets whether it is in location based entertainment, the home PC, games consoles, set top boxes etc.

Design of desktop PCs is tending towards having a single graphics card interfaced by a dedicated high speed bus to the processor and associated memory. The graphics chipsets on such graphics cards, due to the size of the market, are leading technological development and are extremely low cost.

Currently there is no way of synchronising such Commercial-off-The Shelf (COTS) graphics cards in environments where more than one channel of video is required, either for multiple output channels or for multiple sub-images on a single output channel. The devices free run after initialisation and the host processor and display device are slaved to them. There is no designated interface available to be able to re-synchronise the video to another video source originating from similar hardware.

The invention provides a method of synchronising a plurality of video signal generators comprising the steps of;

i) providing a master clock and a slave clock having a small difference in frequency from the master clock,

ii) applying the master clock to a first video signal generator and the slave clock to a second video signal generator;

iii) comparing the phase of field or frame synchronising signals generated by the first and second video signal generators, and

iv) applying the master clock in place of the slave clock to the second video signal generator when the synchronising signals are in phase.

As the master clock and slave clock have slightly different frequencies, the synchronising signals from the video signal generator will converge in phase and when alignment is detected the master clock is substituted for the slave clock to ensure that the video signal generator remain synchronised.

The method may comprise the further steps of;

v) monitoring the slave and master clocks, and

vi) carrying out step iv) only when the master and slave clocks are in phase and both clocks are low.

By ensuring that the switching of the master clock to the slave output takes place only when the master and slave clocks are in phase and both are low prevents irregular clocks being fed to the video signal generator.

The method may further comprise the further step of;

vii) comparing the phase of the line synchronising signals generated by the first and second video signal generators and carrying out step iv) only when the line synchronisation signals are in phase.

By using the line synchronisation signals in addition to the field or frame synchronisation signals the two images may be aligned to pixel accuracy.

The invention further provides an anti-aliasing method for graphics images comprising the steps of;

i) rendering the image using a plurality of video signal generator each producing the same image, the images produced by the video signal generators being offset from each other by a fraction of a pixel,

ii) synchronising the video signal generators using a method of synchronising according to the invention, and

iii) combining the outputs of the video signal generators to produce an averaged video signal output.

The invention still further provides apparatus for synchronising a plurality of independent video signal generators, the apparatus comprising a first input for receiving field or frame synchronising signals from a first video signal generator, a second input for receiving field or frame synchronising signals from a second video signal generator, a comparator for comparing the phase of the first and second synchronisation signals, a master clock generator, a slave clock generator, the slave clock generator having a frequency different from that of the master clock generator, means for applying the master clock signal to a first output for application to the first video signal generator, means for applying the slave clock signal a second output for application to the second video signal generator, and means for means for applying the master clock signal to the second output in place of the slave clock signal when the synchronising signals from the first and second synchronising signals are in phase.

The invention yet further provides apparatus for synchronising a plurality (n) of independent video signal generators, the apparatus comprising a plurality of inputs for receiving field or frame synchronising signals from a corresponding plurality of video signal generators, a master clock generator, (n−1) slave clock generators, n outputs for supplying clock signals to the video signal generators, the master clock and slave clocks being coupled to respective ones of the outputs, n inputs for receiving synchronising signals from the corresponding video signal generators, (n−1) comparators each having a first input for receiving the synchronising signals from the video signal generator that received the master clock signal, a second input for receiving the synchronising signal from the corresponding one of the (n−1) remaining video signal generators, and an output for increasing or decreasing the frequency of the associated slave clock in dependence on the phase difference between the synchronising signals applied to its inputs.

The invention still further provides apparatus for producing anti-aliased images comprising a plurality of video signal generators each producing a common image which is offset by a fraction of a pixel from the images of the other video signal generators, synchronising apparatus for synchronising the video signal generators, the synchronising apparatus being synchronising apparatus according to the invention, and means for combining the outputs of the video signal generators to produce an averaged video signal output.

The invention yet further provides apparatus for generating video images comprising a plurality of video signal generators each arranged to generate a portion of the image, synchronising apparatus for synchronising the video signal generators, the synchronising apparatus being synchronising apparatus according to the invention, and a multiplexer for selecting the output of the appropriate one of the video signal generators, the output of the multiplexer producing a video signal representative of the image to be generated, wherein the multiplexer is switched by a signal derived from the synchronising signals.

The above and other features and advantages of the invention will be apparent from the following description, by way of example, of embodiments of the invention with reference to the accompanying drawings, in which:

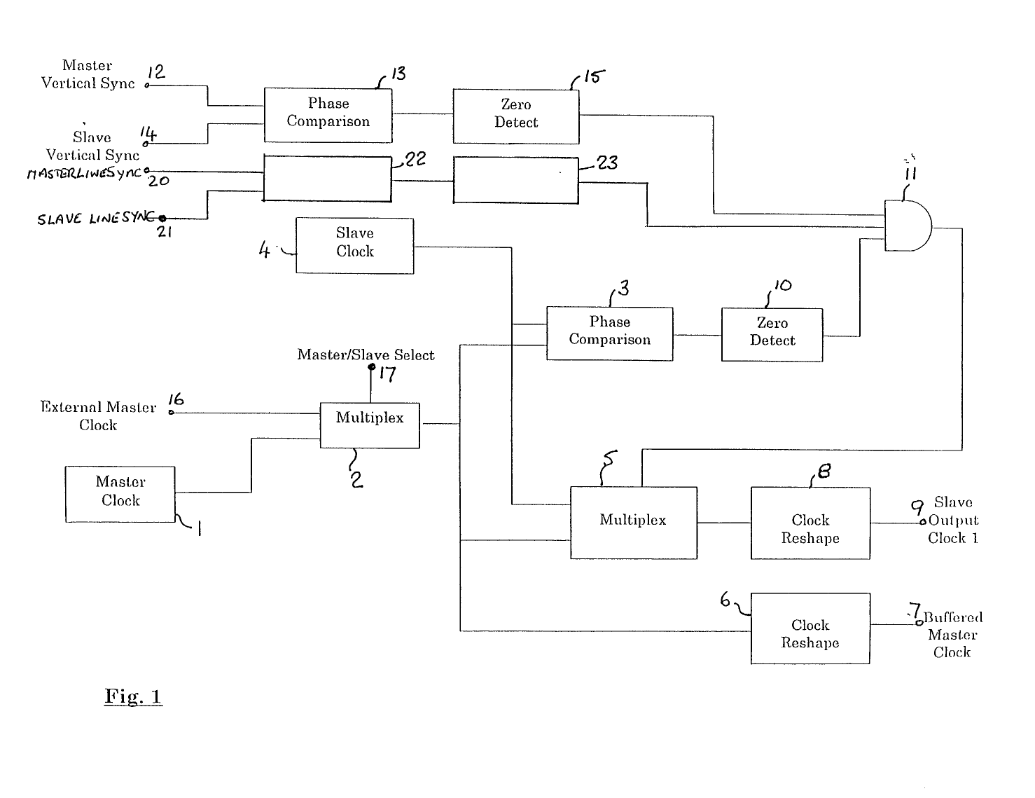

FIG. 1 shows in block schematic form a first embodiment of apparatus for synchronising a plurality of video signal generators according to the invention, the apparatus being arranged to synchronise two video signal generators,

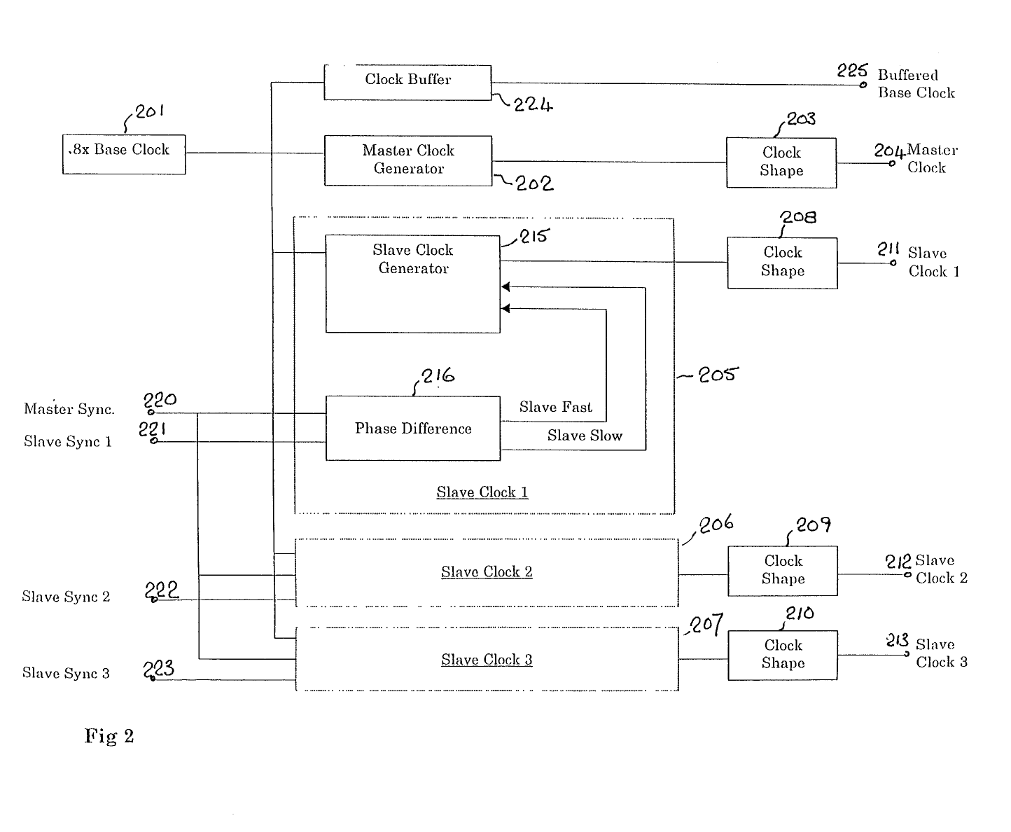

FIG. 2 shows a second embodiment of apparatus for synchronising a plurality of video signal generators according to the invention, the apparatus having four synchronised clock outputs,

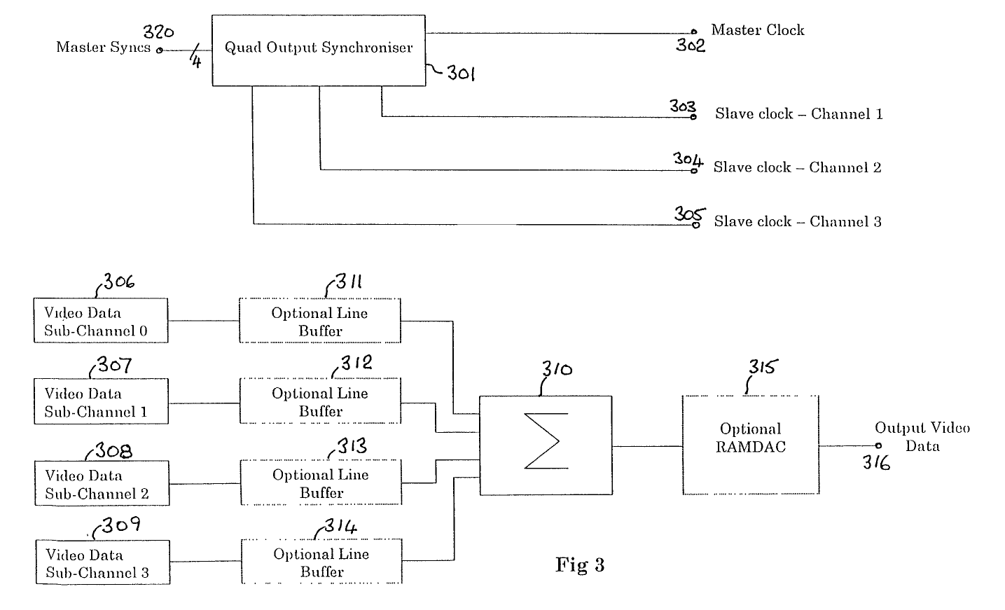

FIG. 3 shows in block schematic form the use of a synchronising apparatus according to the invention in producing an anti-aliased video output,

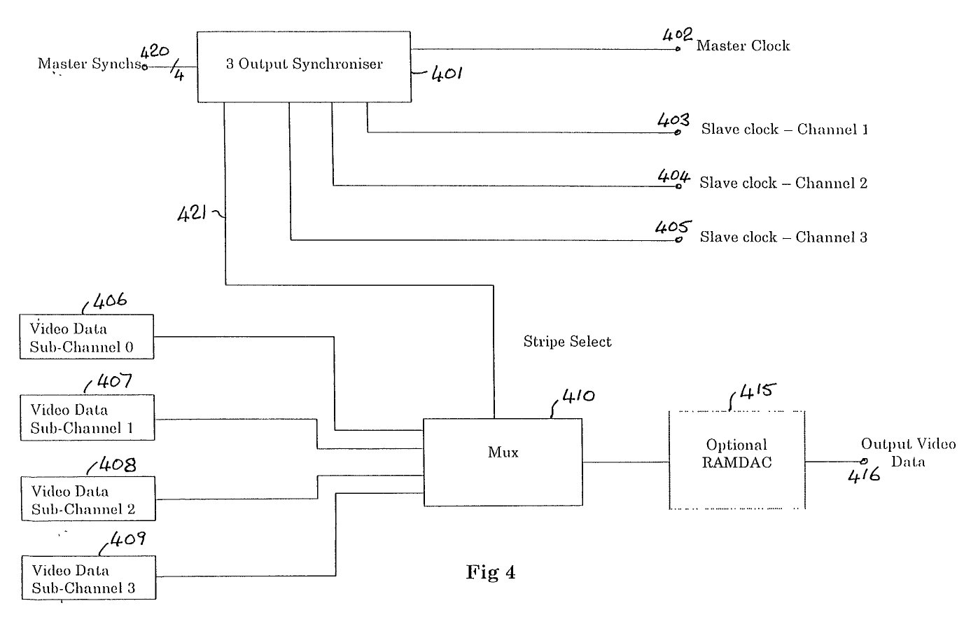

FIG. 4 shows in block schematic form an arrangement in which a synchroniser according to the invention is used to mix images in a striped pattern, and

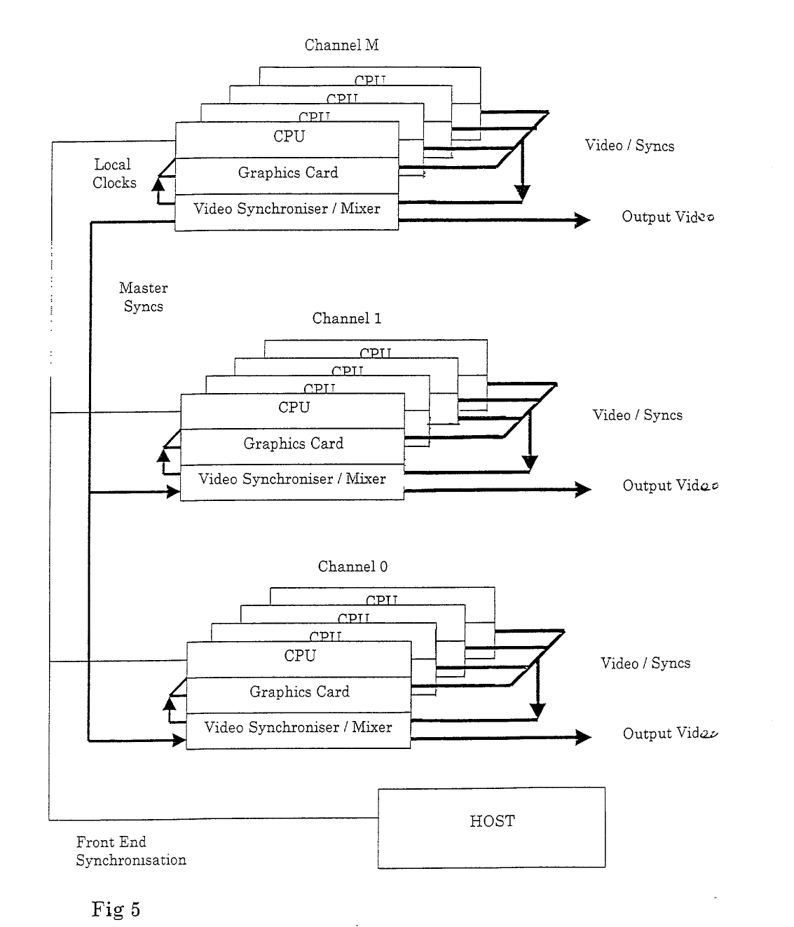

FIG. 5 shows a multiple channel synchronised video system according to the invention.

As shown in FIG. 1, the apparatus for synchronising a plurality of video signal generators, hereinafter referred to as a synchroniser comprises a master clock generator 1 whose output is fed via a multiplexer 2 to a first input of a phase comparator 3. A slave clock 4 has its outputs connected to a second input of the phase comparator 3 and to a first input of a second multiplexer 5. The output of the multiplexer 2 is further fed to a second input of the multiplexer 5 and to the input of the clock reshaping arrangement 6 whose output is fed to an output 7 of the synchroniser at which a buffered master clock signal is produced. The output of the multiplexer 5 is fed to a clock reshaping arrangement 8 whose output is fed to an output 9 of the synchroniser as the slave output clock. The output of the phase comparator 3 is fed to a zero detector 10 which detects when the phase comparator indicates that the slave clock and master clock are in phase. The output of the zero detector 10 is fed to a first input of an AND gate 11. The buffered master clock signal from output 7 is fed to a first video signal generator (not shown) while the buffered slave clock output 9 is fed to a second video signal generator (not shown). The field or frame synchronisation signal produced by the first video signal generator is fed to an input 12 of the synchroniser and to a first input of a phase comparator 13. Similarly, the field or frame synchronisation signal from the second video signal generator is fed to a second input of the phase comparator 13. The output of the phase comparator 13 is fed to a zero detector 15 whose output is fed to a second input of the AND gate 11.

As will be described later, it is possible to assemble systems in which there are multiple synchronisers and in this case, one synchroniser will be a master synchroniser whereas the others will be slaved onto that master synchroniser. In that case, an external master clock is applied to the slave synchronisers via an input 16 and fed to a second input of the multiplexer 2. A master slave select input is applied to input 17 and fed to the multiplexer 2 to determine whether an internal master clock or an external master clock is used.

In operation, the master clock 1 is selected to have a frequency which is the nominal frequency at which the video signal generators operate, whereas the slave clock 4 is selected to have a slightly different frequency, for example, slightly lower in frequency. The actual frequency difference between the master and slave clocks will typically be 1% or less but will be chosen to give the fastest possible convergence without causing loss of detection of convergence by the phase comparator. As described earlier, the invention has particular application to computer generated imagery which may be generated by computer graphics cards available commercially off the shelf. Conventionally, computer graphic cards have their fundamental clocks and more specifically, their output video timing derived from an onboard crystal that is external to the chip set. When using the present invention, the output of the crystal oscillator of a standard computer graphics card is replaced by the clock signals from the synchroniser. The synchroniser hardware has a clock generated from a crystal of similar frequency to that of the graphics card, this is the master clock 1.

The slave clock 4 has a clock generated from a crystal which is slightly lower in frequency than that of the master clock. The first graphics card is designated as the master card and has its chip set driven from the buffered master clock available at output 7 of the synchroniser. The second graphics card is designated as the slave card and has its chip set driven from the buffered slave clock output 9 of the synchroniser. The output timing of the two graphics cards is monitored by sampling the vertical synchronisation signal from both cards, that is, either the field or frame synchronisation signals depending on whether an interlaced or sequential scan is being used. Because the master and slave graphics cards are being driven by different frequency clocks the time difference between the synchronisation signals will converge regardless of how far apart they started. The two vertical synchronisation signals are received at input 12 and 14 and are monitored by the phase comparator 13 whose output will go to zero when the two synchronisation signals are aligned. Similarly the phase comparator 3 will have an output which goes to zero when the slave clock 4 is aligned with the master clock 1 and the zero detection circuits 10 and 15 will detect that state of the phase comparators 3 and 13 and their outputs will cause the AND gate to switch the multiplexer 5 from the slave clock 4 to the master clock 1. Thus the slave clock output at output 9 of the synchroniser will now be derived from the master clock 1. The two video output will then have identical timing until the graphics cards are reset. If however the video timing should become misaligned for any reason the synchroniser will switch in the slave clock to realign the synchronisation signals of the two graphics cards.

The phase comparator 3 is used to monitor the phase difference between the master and slave clocks. This is to ensure that the clocks are switched when they are in phase and both signals are in the low state. Thus the multiplexer 5 will switch only when both inputs to the AND gate 11 are primed. If this precaution was not taken the result would be in irregular clock signal being applied to the graphics chip set. The clock reshaping arrangement 6 and 8 are provided to match the input stage of the graphic chip set.

In order to ensure pixel accuracy in the alignment of the master and slave graphics cards, as is necessary when using multiple graphics cards for producing anti-aliased images, the line synchronising signals are used as well as the field or frame synchronising signals. In order to carry this out the synchroniser has two further inputs 20 and 21 to which the master and slave line synchronising signals are applied and which are connected to respective inputs of a phase comparator 22 whose output is connected to a zero detector 23. The output of the zero detector 23 is connected to a third input of the AND gate 11. In this arrangement the master clock is coupled to the output 9 only when the master and slave field or frame synchronising signals are aligned and the master and slave line synchronising signals are aligned and the master and slave clocks are aligned and both low.

The design can be extended to give a master clock and a plurality of further slave clocks within a single channel by replicating the slave clock, comparator, AND gate and multiplexer for each extra slave graphics card. Typically for a master clock there are three slave clocks enabling 4 graphics cards to be driven from a single synchroniser board.

FIG. 2 shows in block schematic form a second embodiment of a synchroniser according to the invention. In this embodiment a base clock generator 201 is provided which has a frequency of typically eight times the frequency of the master clock generator 202. The master clock generator 202 divides down the frequency of the base clock 201 and passes the generated master clock through a clock shaping arrangement 203 to a master clock output 204. Three slave clock generators 205, 206 and 207 are provided, each having its own clock shaping circuit arrangement 208, 209 and 210 which feed slave clock outputs 211, 212 and 213. The slave clock generators are identical and the first slave clock generator 205 is shown in expanded form. It comprises a clock generator 215 and a phase comparator 216. The clock generator 215, which is typically a state machine, receives an input from the base clock 201 and produces an output which is fed to the clock shaping arrangement 208. An input 220 of the synchroniser receives field (and line where pixel accuracy is required) synchronisation signal from the master graphics card and this is fed to a first input of the phase comparator 216 and to the corresponding phase comparators in the slave clock generators 206 and 207. Two further inputs 222 and 223 receive field (and line where pixel accuracy is required) synchronisation signals from two further slave graphics cards and these are applied to the corresponding phase comparators in the slave clock generators 206 and 207 to the phase comparator 216 in the slave clock generator 205. The base clock 201 is also applied to a clock buffer 224 from whence it is produced at an output 225 as a buffered base clock which can be used elsewhere in the system.

The first embodiment shown in FIG. 1 is typically realised as an analogue hardware system whereas the second embodiment as shown in FIG. 2 will typically be implemented as a gate array. As shown in FIG. 1 the phase detection will normally be performed in the analogue domain using a phase comparator and zero level detector. The clocks will be digitally multiplexed. The accuracy of the level detection is critical to achieve pixel alignment and this design is best suited to applications that require only synchronisation in the field direction. By incorporating a frame buffer, the data from each source can be aligned to pixel accuracy to allow anti-aliasing with one frame latency. This additional frame buffer is often a desirable feature that can allow for post-rendering processes such as the blurring and lookup tables that are applied in sensor simulation. The design shown in FIG. 1 can also be enhanced by additionally incorporating a line buffer. The data from each source can be aligned to pixel accuracy to allow anti-aliasing with one line latency.

In the embodiment of FIG. 2, the clocks are generated from a higher frequency base crystal and the graphics card clocks generated by a state machine. The state machine inserts an additional cycle for the slave clock until the clocks are aligned, thereafter additional cycles can be inserted in either clock to realign them instantly should the video outputs drift for any reason. This is merely precautionary as in most cases, since the cards are driven from the same clock source, drift cannot occur.

The invention enables the alignment of video sources to pixel accuracy which can then be mixed together in either the analogue or digital domain. Several desirable effects can be achieved in this way. For example anti-aliasing by averaging a number of sub-images in either the digital or analogue domain.

FIG. 3 illustrates how the outputs of n graphics cards may be combined using the synchroniser according to the invention. As shown in FIG. 3 a four output synchroniser 301 is provided which may be of the form of either the synchroniser shown in FIG. 1 or that shown in FIG. 2. The synchroniser has four outputs 302,303, 304 and 305. The output 302 being the master clock output and outputs 303 to 305 being slave clock outputs. Four graphics cards are arranged to produce the same image content but each is offset by a small amount from the next, this small amount being less than one pixel. The clocks 302 to 305 are used in the graphics cards which produce the video data sub-channels 306 to 309 respectively. The outputs of the video data sub-channels 306 to 309 are fed to inputs of a summing and averaging arrangement 310. Four line buffers 311 to 314 may be interposed between the output of the video data channels 306 to 309 and the input to the summing and averaging arrangement 310. The output of the summing and averaging arrangement 310 is fed to an output 316 at which the output video data becomes available. Between the output of the summing and averaging arrangement 310 and the output 316, there may be arranged a memory and/or digital to analogue converter 315. The line buffers 311 to 314 may be provided for line processing while a frame store may be provided for frame processing.

An alternative method of creating images that are synchronised is to have a number of graphics cards and arrange for each graphics card to draw only a part of the screen with the remainder being zero. The output images can then be multiplexed together to produce a complete output screen. As shown in FIG. 4, a synchroniser 401 having four outputs 402 to 405 producing the master clock and three slave clocks is provided to control the timing of four graphics cards 406 to 409. The synchroniser 401 receives at an input 420 the field synchronising signals from the four graphics cards and derives from the master synchronising signal an output on a line 421 which causes the multiplexer 410 to select the appropriate one of the four inputs applied to it for output to the output terminal 416. Again, a memory and/or digital to analogue converter 415 may be provided between the output of the multiplexer 410 and the output 416 of the arrangement. It should be noted that it is necessary for the images to be pixel synchronised or aligned to avoid unwanted artifacts caused by timing errors between adjacent lines where the area written by one graphics cards meet that written by a different graphics card.

FIG. 5 shows a multiple channel synchronised system. Each channel comprises four graphics cards each having an associated CPU and a video synchroniser as shown in the embodiments of FIGS. 1 or 2. When used for anti-aliasing the video synchroniser/mixer will be of the form shown in FIG. 3, while when used for generating the data for part of a screen, the video synchroniser/mixer will be of the form shown in FIG. 4. As shown in FIG. 5, the channel M has the master synchroniser and the synchronisation signals for the video synchronisers in the other channels are derived from the input 420 of FIG. 4 or 320 of FIG. 3. Typically, each channel consists of four graphics cards that are pixel synchronised and mixed together to display four sub-pixel anti-aliased images. In this multi channel system, each channel is vertically synchronised. This ensures that no artifacts exist between adjacent channels and that no timing delays are introduced by the channels completing their drawing tasks at different times.

If desired each channel may be pixel synchronised by ensuring the master syncs include both field or frame and line synchronisation signals. In this case anti-aliasing using more than four pixel offsets can be employed by combining two or more output video signals.

Alternative ways of using the system shown in FIG. 5 include using one channel to produce an anti-aliased part of an image, a number of channel then being combined to produce the whole image. Alternatively each channel could produce a full image by combining the partial images of the graphics cards in the channel and then combining a plurality of channels to produce an anti-aliased image.

1. A method of synchronising a plurality of video signal generators comprising the steps of;
i) providing a master clock and a slave clock having a small difference in frequency from the master clock,
ii) applying the master clock to a first video signal generator and the slave clock to a second video signal generator;
iii) comparing the phase of field or frame synchronising signals generated by the first and second video signal generators, and
iv) applying the master clock in place of the slave clock to the second video signal generator when the synchronising signals are in phase.

2. A method as claimed in claim 1 comprising the further steps of;
v) monitoring the slave and master clocks, and
vi) carrying out step iv) only when the master and slave clocks are in phase and both clocks are low.

3. A method as claimed in claim 1 in which the frequency of the slave clock is lower than that of the master clock.

4. A method as claimed in any of claim 1 comprising the further step of;
vii) comparing the phase of the line synchronising signals generated by the first and second video signal generators and carrying out step iv) only when the line synchronisation signals are in phase.

5. A method as claimed in claim 2 comprising the further step of;
vii) comparing the phase of the line synchronising signals generated by the first and second video signal generators and carrying out step iv) only when the line synchronisation signals are in phase.

6. An anti-aliasing method for graphics images comprising the steps of;
i) rendering the image using a plurality of video signal generators each producing the same image, the images produced by the video signal generators being offset from each other by a fraction of a pixel,
ii) synchronising the video signal generators using a method as claimed in any preceding claim, and
iii) combining the outputs of the video signal generators to produce an averaged video signal output.

7. Apparatus for synchronising a plurality of independent video signal generators, the apparatus comprising a first input for receiving field or frame synchronising signals from a first video signal generator, a second input for receiving field or frame synchronising signals from a second video signal generator, a comparator for comparing the phase of the first and second synchronisation signals, a master clock generator, a slave clock generator, the slave clock generator having a frequency different from that of the master clock generator, means for applying the master clock signal to a first output for application to the first video signal generator, means for applying the slave clock signal to a second output for application to the second video signal generator, and means for applying the master clock signal to the second output in place of the slave clock signal when the synchronising signals from the first and second synchronising signals are in phase.

8. Apparatus as claimed in claim 7 comprising a second comparator for comparing the phase of the master clock and the slave clock, wherein the operation of the means for applying the master clock to the second output is dependent also on the output of the second comparator.

9. Apparatus as claimed in claim 7 comprising a third input for receiving line synchronising signals from the first video signal generator, a fourth input for receiving line synchronisation signals from the second video signal generator, and a comparator for comparing the phase of the first and second line synchronisation signals, wherein the operation of the means for applying the master clock to the second output is dependant also on the output of the third comparator.

10. Apparatus as claimed in claim 8 comprising a third input for receiving line synchronising signals from the first video signal generator, a fourth input for receiving line synchronisation signals from the second video signal generator, and a comparator for comparing the phase of the first and second line synchronisation signals, wherein the operation of the means for applying the master clock to the second output is dependant also on the output of the third comparator.

11. Apparatus as claimed in claim 7 in which the frequency of the slave clock is lower than that of the master clock.

12. Apparatus for synchronising a plurality (n) of independent video signal generators, the apparatus comprising a plurality of inputs for receiving field or frame synchronising signals from a corresponding plurality of video signal generators, a master clock generator, (n−1) slave clock generators, n outputs for supplying clock signals to the video signal generators, the master clock and slave clocks being coupled to respective ones of the outputs, n inputs for receiving synchronising signals from the corresponding video signal generators, (n−1) comparators each having a first input for receiving the synchronising signals from the video signal generator that received the master clock signal, a second input for receiving the synchronising signal from the corresponding one of the (n−1) remaining video signal generators, and an output for increasing or decreasing the frequency of the associated slave clock in dependence on the phase difference between the synchronising signals applied to its inputs.

13. Apparatus as claimed in claim 12 wherein the plurality of inputs further receive line synchronising signals from the corresponding plurality of video signal generators.

14. Apparatus for producing anti-aliased images comprising a plurality of video signal generators each producing a common image which is offset by a fraction of a pixel from the images of the other video signal generators, synchronising apparatus for synchronising the video signal generators, the synchronising apparatus being as claimed in claim 9 and means for combining the outputs of the video signal generators to produce an averaged video signal output.

15. Apparatus for producing anti-aliased images comprising a plurality of video signal generators each producing a common image which is offset by a fraction of a pixel from the images of the other video signal generators, synchronising apparatus for synchronising the video signal generators, the synchronising apparatus being as claimed in claim 12 and means for combining the outputs of the video signal generators to produce an averaged video signal output.

16. Apparatus for producing anti-aliased images comprising a plurality of video signal generators each producing a common image which is offset by a fraction of a pixel from the images of the other video signal generators, synchronising apparatus for synchronising the video signal generators, the synchronising apparatus being as claimed in claim 13 and means for combining the outputs of the video signal generators to produce an averaged video signal output.

17. Apparatus as claimed in claim 14 in which the anti-aliased image is stored in memory.

18. Apparatus as claimed in claim 15 in which the anti-aliased image is stored in memory.

19. Apparatus as claimed in claim 16 in which the anti-aliased image is stored in memory.

20. Apparatus as claimed in claim 14 including a digital to analogue converter for converting the anti-aliased image signal to an analogue signal for application to display means.

21. Apparatus as claimed in claim 17 including a digital to analogue converter for converting the anti-aliased image signal to an analogue signal for application to display means.

22. Apparatus for generating video images comprising a plurality of video signal generators each arranged to generate a portion of the image, synchronising apparatus for synchronising the video signal generators, the synchronising apparatus being as claimed in claims 7, and a multiplexer for selecting the output of the appropriate one of the video signal generators, the output of the multiplexer producing a video signal representative of the image to be generated, wherein the multiplexer is switched by a signal derived from the synchronising signals.

23. Apparatus as claimed in claim 22 in which the generated image is stored in memory.

24. Apparatus as claimed in claim 22 including a digital to analogue converter for converting the generated image signal to an analogue signal for application to display means.

25. Apparatus as claimed in claim 23 including a digital to analogue converter for converting the generated image signal to an analogue signal for application to display means.
